(19) United States
(12) Patent Application Publication
(10) Pub. No.: US 2006/0103847 A1
(43) Pub. Date: May 18, 2006

(54) Device for the detection of holes in continuously-advancing bands of material

(75) Inventors: Benoit Moulas, Aucamville (FR); Pascal Geyre, Muret (FR); Marc Brouant, Marquein (FR)

Correspondence Address: OLIFF & BERRIDGE, PLC, P.O. BOX 19928, ALEXANDRIA, VA, 22320, US

(73) Assignee: ARCK ELECTRONIQUE, RAMONVILLE SAINT AGNE (FR)

(21) Appl. No.: 10/545,131

(22) PCT Filed: Mar. 19, 2004
(86) PCT No.: PCT/FR04/00679

§ 371 Date: Aug. 10, 2005

(30) Foreign Application Priority Data
Mar. 20, 2003 (FR) 03/03437

(51) Int. Cl. G01N 21/84; G01N 21/86

(52) U.S. Cl. 356/431; 250/559.01; 250/559.04; 250/559.13; 250/559.15; 356/430

(57) ABSTRACT

A device to detect holes in a continuously winding strip of material of the type formed of a vertical frame which, placed in the path of said strip of material via a horizontal slot delimiting said frame into two upper and lower bodies, each opening onto said slot via windows opened opposite one another, said upper body being intended to support a first optical sub-assembly for emission for a source of light in the direction of said strip passing below said upper body, and said lower body being intended to support a second optical sub-assembly for reception for said light emitted by said first sub-assembly and able to filter through said holes in said strip of material passing above said trip, wherein said first optical sub-assembly for emission is constituted by a stimulated emission of radiation, called laser radiation, and said optical sub-assembly for reception is constituted by photodiodes sensitive to the low luminous flux emitted by said laser radiation.

### BACKGROUND OF THE INVENTION

The present invention relates to the inspection domain and namely that of detecting the presence of holes in materials in sheet form and more particularly to check steel coils reeling off as a continuous strip at great speed.

### DESCRIPTION OF PRIOR ART

Generally speaking, the detection of holes in steel sheeting of a thickness of approximately 0.25 mm reeled off in a continuous strip at speeds of around 10 m/s is a complicated operation to perform whereas detection must be accurate since the holes, cracks or other slit defects often have very reduced diameters (a few tens of microns) such that distinguishing them is not always easy to implement technically.

In prior art there are some devices to detect holes in continuously winding strips of material. Such devices, generally called hole detectors, are classically constituted by a vertical frame placed in the path of the strip of material reeled off continuously and in a horizontal plane passing through said frame via a horizontal slot arranged therein that is sufficiently wide to enable the said strip to move freely through said detector without hindrance, such passage being transitory and during which the strip is inspected for defects. This horizontal slot delimits two upper and lower bodies, each fitted with a window opposite one another and on either side of said slot. The first body defines a logical structure for a first optical emission sub-assembly, via its window opening onto the slot, generating a source of light in the direction of said strip passing below and the second defining a logical structure for a second optical reception sub-assembly, via its window opening onto the slot, to capture said light emitted by the first optical sub-assembly and likely to filter through the strip of material passing above.

Thus, the detection devices are placed in the path of the passing strip of material with the two optical sub-assembly placed on either side of said strip which they imprison inside a generally dark chamber for the time of its passage so as to ensure continuous optical scanning along a line crosswise to the direction of movement of the strip without interrupting its movement at any time.

The applicant has observed that the detection of holes in continuously winding strip of material such as is classically performed by prior devices presents certain drawbacks concerning its implementation and efficiently.

Thus, as it is passing through the detection apparatus, the metal strip may also evolve transversally in the slot either by variations in its width or by oscillations to which the inspection sub-assemblies must all at costs become adapted. It is also very important to insulate, in the dark chambers, all the detection optics from any parasitic light, that is to say any ambient light and/or light reflected from the light source of the optical emission sub-assembly.

In a generally well known and used manner in the field of metallurgy, the optical emission sub-assembly implements ultra-violet light produced by fluorescent lamps (for example, neon lights) and the optical reception sub-assembly implements ultra-sensitive photoelectric sensors, called photomultipliers. The processing of the output data from the optical reception sub-assembly supplies an output signal that is amplified and shaped so as to be compared to a voltage threshold so as to produce an “all-or-nothing” datum which does not allow the winding/unwinding machine to spot the portion of the material strip that is perforated and thus unusable.

Additionally, and thanks to the use of suitable optical filters, the photoelectric sensors have a sensitivity centered on blue and ultra-violet thereby enabling low-powered neon lamps to be used whilst avoiding disturbances linked to the infrared spectrum due to the strips of steel moving at temperatures of between 25° C. and 70° C.

However, the selection of a low-powered light emission requires very great amplification ratios for the optical reception sub-assembly in photomultipliers with substantial gain (which can attain a million) thereby requiring the terminals of these photomultipliers to be polarized with high voltages of a few hundred to a few thousand volts. This inevitably results in relatively high costs of maintenance and replacement (neon lights being very expensive) which means that these detectors working in “all-or-nothing” mode are no longer adapted to the high expectations of industrialists who require more and more that materials be produced in strips with ever more constraining discriminations (smaller and smaller dimensions) and for the holes detected to be more easily parametered (shapes and quantities).

### DESCRIPTION OF THE INVENTION

On this basis and with pre-established specifications, the applicant has performed research on a new concept of hole detection in material sheets reeled off continuously in the form of strips which overcomes the drawbacks of prior art and fulfils the requirements of the industrialists.

This research has led to an original concept for a detection device that is particularly simple and advantageous and which requires less polarization of the detection optical sub-assembly, lower maintenance and replacement costs for the components, and offers improved inspection possibilities for the strips under inspection, etc.

According to the invention, the device to detect holes in a continuously winding strip of material is of the type formed of a vertical frame which, placed in the path of the strip of material via a horizontal slot delimiting said frame into two upper and lower bodies, the upper body intended to support a first optical emission sub-assembly for a source of light in the direction of said strip passing below it via a window opening onto said slot, and the lower body intended to support a second optical reception sub-assembly for said light emitted by the first optical sub-assembly and able to filter through the holes in the strip of material passing above it, via a second window arranged in the lower body opposite the first window opened in the upper body.

According to the original concept implemented in the present invention, said optical emission sub-assembly is constituted by so-called laser radiation, a stimulated radiation emission and said optical reception sub-assembly is constituted by photodiodes sensitive to the low luminous flux emitted by the laser radiation.

The advantage of a receiver according the invention in the form of semi-conductor diodes which, preferably will be so-called avalanche diodes, is to have sensitivity to low luminous flux and a long service life. Indeed, avalanche photodiodes which have a gain of 100 or 200 enables sensitivities which enables the generation of a current of 44 mA for a low luminous flux received around of 1 mW, for example between 0.5 and 10 mW. This range of value of the low luminous flux emitted by the laser radiation across the holes is then received by the second sub-assembly.

The bandwidth of these components is thus compatible with the light pulse at 1 μs which must be, generally speaking, that detected by such detection device.

Because of the low gains of the optical reception sub-assembly photodiodes, the optical emission sub-assembly is, according to the invention, constituted by so-called laser radiation, a stimulation radiation emission whose first property is to increase the luminous efficiency of the emission source thereby, in association with the optical reception sub-assembly, ensuring very satisfactory detection results.

Indeed, it is worth remembering that a few milliwatts of radiation produced by a laser diode supplies an output of several thousand apparent watts since the beam is collimated on output so as to only produce a low diameter luminous spot.

According to a preferred characteristic of the invention, the optical emission sub-assembly comprises a strip of several laser diodes positioned in parallel and above said passage slot for the strip of material to be inspected such that the luminous source formed by this light strip is able to spread over the full width of the strip of material. This light strip will preferably incorporate two parallel rows of diodes positioned evenly offset with respect to one another so that the luminous beams of the diodes from one row overlap with those of the other row thus avoiding the presence of any “dark holes”.

Moreover, given that the collimated luminous laser radiation beam only produces a luminous spot of small diameter, the applicant thought of equipping each of said laser diodes with a line generating lens able to diverge the laser beam thereby making it able to scan a greater useful detection zone. This line generating lens will be of the type giving a constant relative intensity over all the line, that is to say both in the center and at the ends of the line.

### BRIEF DESCRIPTION OF THE DRAWINGS

Other advantages and characteristics will become more apparent from the following description which gives by way of non-exhaustive example in reference to the appended drawings one embodiment of a hole detection device for a continuously winding strip of material.

FIG. 1 is a perspective view of a device according to the invention.

FIG. 2 is a partially stripped perspective view of the device in FIG. 1.

FIG. 3 is a schematic top view of a horizontal section of this device.

FIG. 4 is a schematic view of a vertical section illustrating the optical phenomenon in operation in this device.

### DESCRIPTION BASED ON THE DRAWINGS

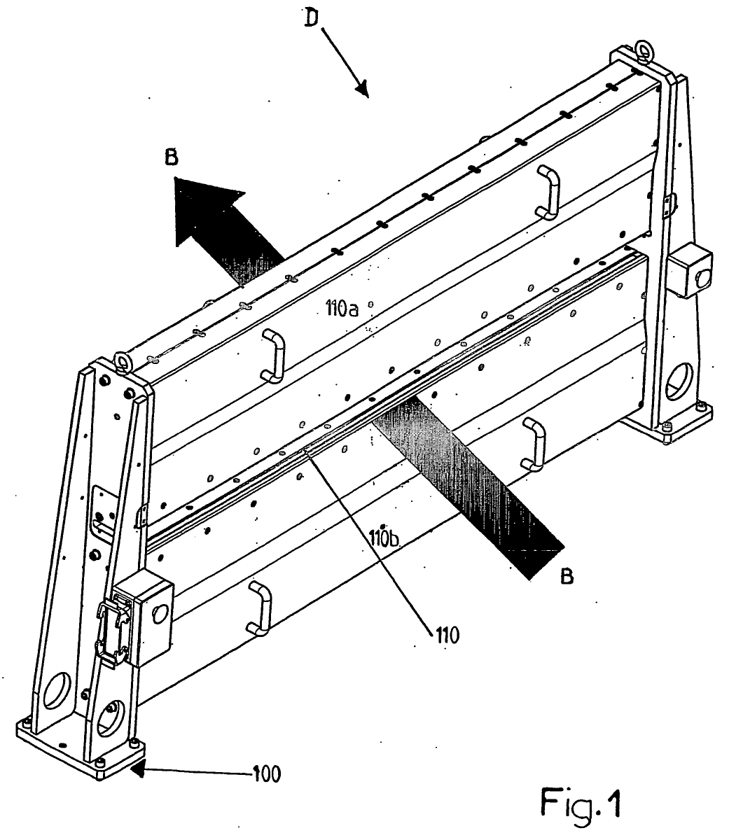

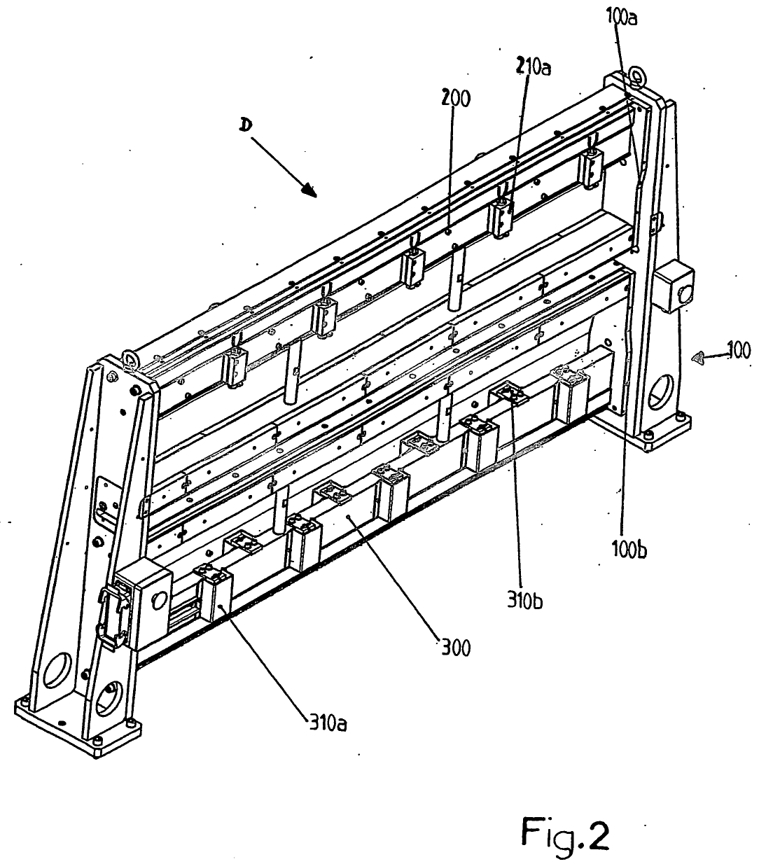

As shown in the drawings in FIGS. 1 and 2, the hole detection device, reference D as a whole, is constituted by a vertical frame 100 intended to be positioned in the path of a continuously winding strip of material (symbolized by double arrow B) via a horizontal slot 110 arranged substantially half way up the frame 100. The latter is made of poles, beams and cross pieces technically arranged together to delimit, on either side of said slot 110, an upper body 100a and a lower body 100b both fitted with removable body plates but each opening onto the slot 110 via an open window lying opposite one another.

As may be seen from the drawing in FIG. 2 which shows the frame 100 stripped on one side of its body elements, the upper body 100a defines a logical structure of a first optical sub-assembly 200 that emits a source of light through the slot 110 in direction of the strip passing above (arrow B) and the lower body 100b defines a logical structure for a second so-called optical reception sub-assembly 300.

The purpose of this second sub-assembly 300 is to capture the light from the first optical sub-assembly 200 likely to filter through any holes in the strip of material passing above and in slot 110 so as to supply a corresponding output signal informing the machine fitted with said detection device of the presence of holes on such and such portion of the strip that has just been inspected.

This second sub-assembly is able to receive the low luminous flux of around 1 mW emitted by the laser radiation of the first sub-assembly 200 across the holes.

One of the main objects of the invention lies in the original implementation of the two optical sub-assemblies 200 and 300.

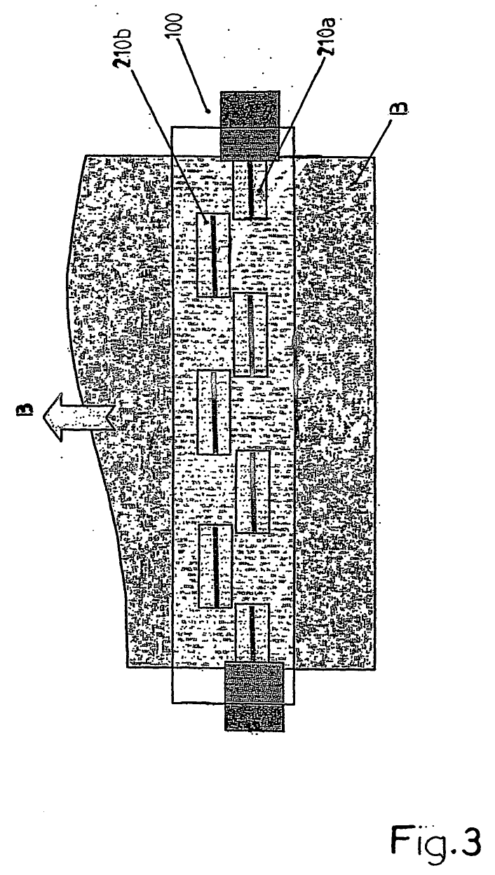

Thus, the optical emission sub-assembly 200, shown in greater detail in the drawing in FIG. 3, is constituted by so-called laser radiation, a stimulated emission of radiation, obtained by a strip of two rows of laser diodes 210a and 210b arranged in parallel to one another and positioned above said slot 110 above the strip of material to be inspected.

An opposite arrangement may naturally also be imagined in the same manner. The laser diodes of each row 210a and 210b of the light strip of the optical emission sub-assembly 200 are each equipped with a line generating lens to diverge the laser beam so as to provide scanning of a greater useful detection zone than the luminous spot that is generally the output of such diodes.

In addition, the laser diodes are arranged evenly offset with respect to one another in the direction of the slot 110 such that the luminous beams from the diodes of one row 210a overlap those of the row of diodes 210b, and vice versa, thereby covering the full length of the slot and avoiding any “dark holes”.

According to an identical arrangement, the second optical sub-assembly 300 of reception is constituted by a strip of photodiodes sensitive to the low luminous flux emitted by the radiation from the laser diodes and also arranged in two rows of photodiodes 310a and 310b positioned in parallel below said slot 110 and the strip of material to be inspected and opposite the laser diodes of rows 210a and 210b so as to capture the laser radiation filtering though any holes in the material passing continuously in the detection device according to the invention, via slot 110.

The presence of a series of diodes in the form of a strip of two rows, both for the emission sub-assembly 200 (rows 210a and 210b) and for the reception sub-assembly 300 (rows 310a and 310b), has the great advantage, in addition to that of the optical capacities explained at the beginning of this expose, of being able to easily adapt the light strips of the sub-assemblies 200 and 300 to the width of the strip of material which will generally be inspected by the detection device according to the invention.

Thus, for example, if the width of the strip to be inspected by the detection device according to the invention is of around 1,300 mm and the field of the laser radiation beam of each optical sub-assembly diode 200 is of 200 mm, the strips of each optical sub-assembly 200 and 300 may be equipped respectively with seven laser diodes and seven photodiodes with an overlap of around 1 to 10 mm between the light beams of the laser diodes.

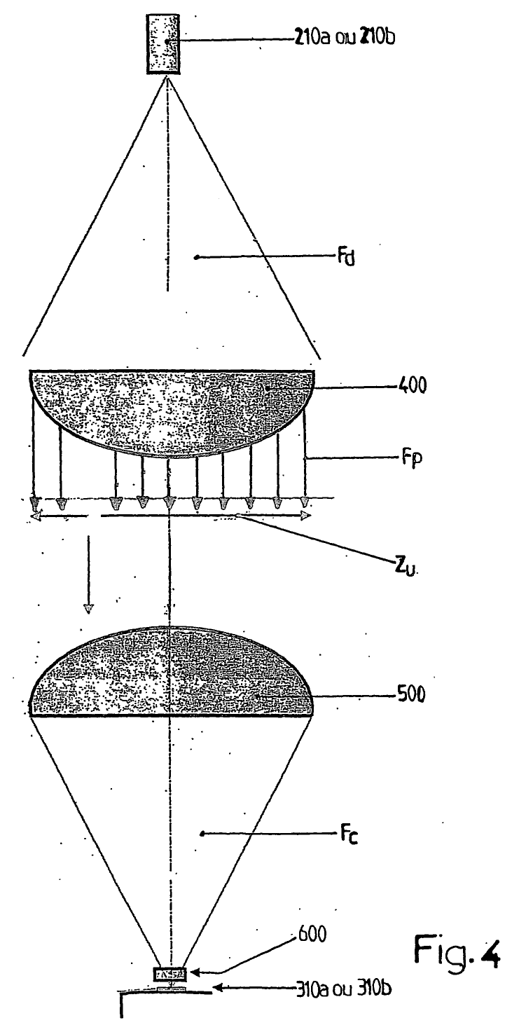

Each of the laser diodes of rows 210a or 210b fitted with a line generating lens thus generates an output of a laser line with a divergent beam Fd which, according to a preferred embodiment of the invention shown in the drawing in FIG. 4, will be collimated by placing a so-called divergent plano-convex cylindrical lens 400 between each of said laser diodes 210a and 210b.

The slot 110 above the strip of material to be inspected and placed on said incident divergent beam Fd to deviate it and transform it into a parallel beam Fp transversal to the strip to be inspected and perpendicular to the plane of said last rip thus defining a useful detection zone Zu on a width of inspected strip.

The number of diodes 210a and 210b will thus be defined by the ratio of the width of the strip to be inspected on the dimensions of the useful detection zone Zu of the parallel beam Fp emerging from the plano-convex cylindrical lenses 400.

In an identical manner, but arranged below the slot 110 between the strip to be inspected and the photodiodes 310a and 310b of the optical reception sub-assembly 300, another so-called convergent plano-convex cylindrical lens 500 will be judiciously positioned on said parallel beam Fp to make it deviate and transform it into a beam Fp converging to one of the photodiodes 310a or 310b of the optical reception sub-assembly 300, possibly via interferential filters 600 judiciously arranged by somebody skilled in the art.

It is understood that the detection device that has just been described has been done so for purposes of disclosure rather than limitation. Naturally, various arrangements, modifications ad improvements may be made to the above example, without necessarily departing from the scope of the invention as claimed.

Thus, for example, the applicant has imagined installing laser diodes 210a, 210b, plano-convex lenses 400, 500 and photodiodes 310a, 310b in flanges or other removable flanging devices in order to facilitate the installation, removal and setting operations with a view to replacement.

Similarly, it will be possible to envisage replacing each of the optical lenses 400 and 500 by a series of lenses organized with the same purpose as that of lenses 400 and 500, that is to say to transform the divergent beam Fd into a parallel beam Fp for the first series of lenses and making said parallel beam Fp deviate to transform it into a beam Fp converging towards the photodiodes 310a or 310b for the second series of lenses.

1. A device to detect holes in a continuously winding strip of material of the type formed of a vertical frame which, placed in the path of said strip of material via a horizontal slot delimiting said frame into two upper and lower bodies, each opening onto said slot via windows opened opposite one another, said upper body being intended to support a first optical sub-assembly for emission for a source of light in the direction of said strip passing below said upper body, and said lower body being intended to support a second optical sub-assembly for reception for said light emitted by said first sub-assembly and able to filter through said holes in said strip of material passing above said trip, wherein said first optical sub-assembly for emission is constituted by a stimulated emission of radiation, called laser radiation, and said second optical sub-assembly for reception is constituted by photodiodes sensitive to the low luminous flux emitted by said laser radiation.

2. A detection device according to claim 1, wherein said laser radiation of said first optical sub-assembly is constituted by a strip of several laser diodes able to spread over the full width of said strip of material.

3. A detection device according to claim 1, wherein said second optical sub-assembly for reception is constituted by a strip of several photodiodes sensitive to the low luminous flux emitted by the radiation of said laser diodes.

4. A detection device according to claim 1, wherein said first optical sub-assembly for emission comprises a strip of two rows of laser diodes arranged in parallel to one another and above said slot and said strip of material to be inspected and evenly offset with respect to one another along said slot so that the luminous beams of said diodes of one row overlap with those of the other row, and vice versa.

5. A detection device according to claim 1, wherein each of said laser diodes is equipped with a line generating lens making the laser beam diverge so that said beam can scan a greater useful detection zone (Zu) than the luminous spot output from said diodes.

6. A detection device according to claim 4, wherein said second optical sub-assembly comprises a strip of two rows of photodiodes arranged in parallel above said slot and said strip of material to be inspected and opposite said laser diodes so as to capture the laser radiation filtering though each of said holes in the continuously passing strip via said slot.

7. A detection device according to claim 6, wherein a so-called divergent plano-convex cylindrical lens is placed between the divergent beam (Fd) output from each of said laser diodes to make said beam (Fd) deviate and transform said beam into a parallel beam (Fp) transversal to said strip to be inspected and perpendicular to the plane of the latter so as to define a useful detection zone (Zu) on a width of said strip.

8. A detection device according to claim 7, wherein a so-called convergent plano-convex cylindrical lens is placed on the parallel beam (Fp) below said slot between said strip to be inspected and said photodiodes of said optical sub-assembly to make said parallel beam (Fp) deviate and transform it into a beam (Fp) converging towards said photodiodes of said optical sub-assembly.

9. A detection device according to claim 8, wherein the number of said laser diodes of said first optical sub-assembly is the same as the number of said photodiodes of said optical sub-assembly.

10. A detection device according to claim 9, wherein said device incorporates interferential filters arranged in front of said photodiodes of said second optical sub-assembly.

11. A detection device according to claim 10, wherein said laser diodes and/or said plano-convex lenses and/or said photodiodes are mounted and set in removable flanging devices.

12. A detection device according to claim 1, wherein said low luminous flux emitted by said laser radiation is around 1 mW.
